(19) United States
(12) Patent Application Publication
(10) Pub. No.: US 2017/0349181 A1
(43) Pub. Date: Dec. 7, 2017

(54) LANE MANAGEMENT SYSTEM FOR AN AUTOMATED VEHICLE

(71) Applicant: DELPHI TECHNOLOGIES, INC., TROY, MI (US)

(72) Inventors: JUNQING WEI, BRIDGEVILLE, PA (US); WENDA XU, PITTSBURGH, PA (US); JONG HO LEE, PITTSBURGH, PA (US); GAURAV BHATIA, PITTSBURGH, PA (US); JUNSUNG KIM, PITTSBURGH, PA (US)

(21) Appl. No.: 15/171,174

(22) Filed: Jun. 2, 2016

(51) Int. Cl. B60W 30/18; G01C 21/34; G05D 1/00

(52) U.S. Cl. CPC B60W 30/18163; G05D 1/0088; G01C 21/34; B60W 2550/20

(57) ABSTRACT

A lane management system for operating an automated vehicle includes a navigation-device, a vehicle-detector, and a controller suitable for use on a host-vehicle. The navigation-device is used to determine a preferred-route to a destination of the host-vehicle. The vehicle-detector is used to determine a relative-location of an other-vehicle proximate to the host-vehicle. The controller is in communication with the navigation-device and the vehicle-detector. The controller is configured to determine an alternate-route when the relative-location is such that a preferred-lane of the preferred-route is obstructed whereby the host-vehicle is unable to follow the preferred-route. Alternatively, the controller is configured to determine an initiate-time to perform a lane-change necessary to maneuver the host-vehicle into a preferred-lane of the preferred-route so the host-vehicle can follow the preferred-route, wherein the initiate-time is determined based on the relative-location.

### TECHNICAL FIELD OF INVENTION

This disclosure generally relates to a lane management system for operating an automated vehicle, and more particularly relates to a system that determines an alternate-route when the relative-location of an other-vehicle is such that a preferred-lane of a preferred-route is obstructed by the other-vehicle.

### BACKGROUND OF INVENTION

Automated vehicles that select a preferred-route to a destination are known. The timing of when lane changes are made can affect the quality of the passenger experience as the automated vehicle drives itself to the destination. For example, it is preferable to delay traveling in the right-most lane of a roadway that has numerous vehicles entering and exiting the roadway via the right-most lane until as late as possible. However, unexpected traffic situations may prevent the automated vehicle from actually following the preferred-route.

### SUMMARY OF THE INVENTION

In accordance with one embodiment, a lane management system for operating an automated vehicle is provided. The system includes a navigation-device, a vehicle-detector, and a controller suitable for use on a host-vehicle. The navigation-device is used to determine a preferred-route to a destination of the host-vehicle. The vehicle-detector is used to determine a relative-location of an other-vehicle proximate to the host-vehicle. The controller is in communication with the navigation-device and the vehicle-detector. The controller is configured to determine an alternate-route when the relative-location is such that a preferred-lane of the preferred-route is obstructed whereby the host-vehicle is unable to follow the preferred-route.

In another embodiment, a lane management system for operating an automated vehicle is provided. The system includes a navigation-device, a vehicle-detector, and a controller suitable for use on a host-vehicle. The navigation-device is used to determine a preferred-route to a destination of the host-vehicle. The vehicle-detector is used to determine a relative-location of an other-vehicle proximate to the host-vehicle. The controller is in communication with the navigation-device and the vehicle-detector. The controller is configured to determine an initiate-time to perform a lane-change necessary to maneuver the host-vehicle into a preferred-lane of the preferred-route so the host-vehicle can follow the preferred-route, wherein the initiate-time is determined based on the relative-location.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a lane management system in accordance with one embodiment; and

FIG. 2 is a traffic-scenario encountered by the system of FIG. 1 in accordance with one embodiment.

### DETAILED DESCRIPTION

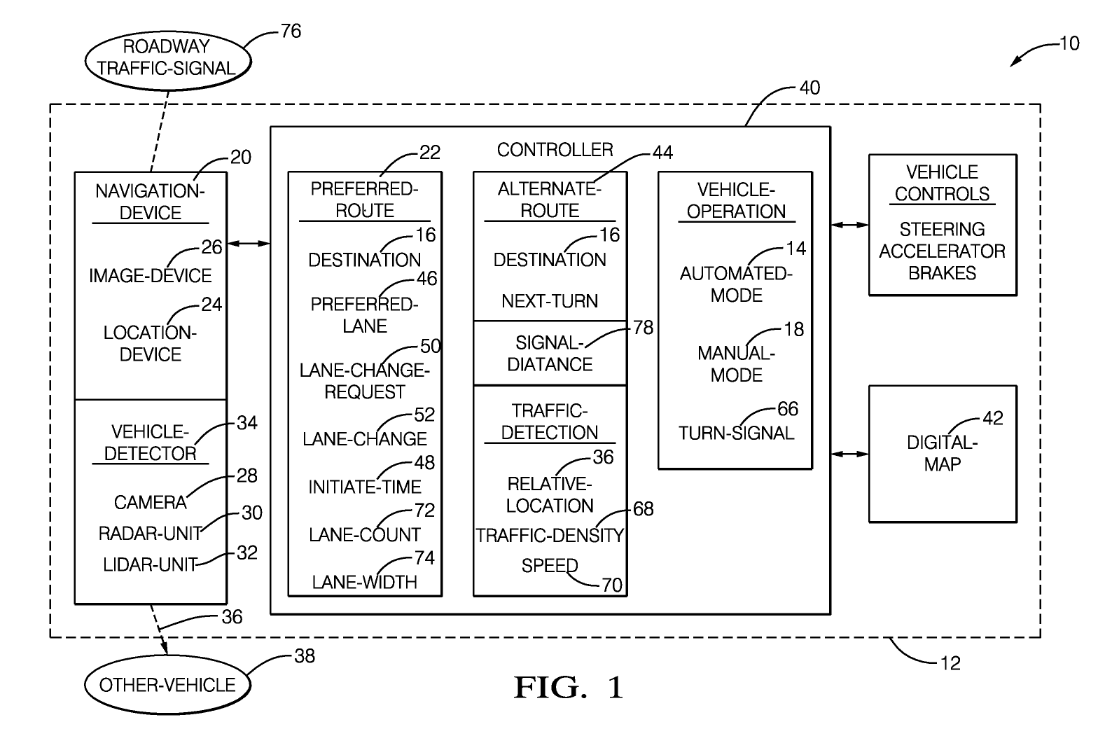

FIG. 1 illustrates a non-limiting example of a lane management system 10, hereafter referred to as the system 10, which is generally configured for operating an automated vehicle, for example a host-vehicle 12. The examples presented herein are generally directed to instances when the host-vehicle 12 is being operated in an automated-mode 14, i.e. a fully autonomous mode, where a human operator (not shown) of the host-vehicle 12 does little more than designate a destination 16 to operate the host-vehicle 12. However, it is contemplated that the teachings presented herein are useful when the host-vehicle 12 is operated in a manual-mode 18 where the degree or level of automation may be little more than providing steering advice to the human operator who is generally in control of the steering, accelerator, and brakes of the host-vehicle 12, i.e. the system 10 assists the human operator as needed to reach the destination 16 and/or avoid a collision.

The system 10 includes a navigation-device 20 suitable for use on the host-vehicle 12 because the navigation-device 20 is designed to operate over the temperature range and other environmental conditions that the host-vehicle 12 may experience. In general, the navigation-device 20 is used by a controller 40 (described in more detail later) of the system 10 to determine a preferred-route 22 to the destination 16 of the host-vehicle 12. The navigation-device 20 may consist of, but is not limited to, a location-device 24 such as a global-position-system (GPS) receiver used to determine the location of the host-vehicle 12 on a digital-map 42. Alternatively, or in combination with the GPS receiver, the navigation-device 20 may include an image-device 26, the function of which may be provided by, but not limited to, a camera 28, a radar-unit 30, a lidar-unit 32, or any combination thereof. While these devices are illustrated as being part of or forming a vehicle-detector 34, it is contemplated that these devices may also be used by the navigation-device 20 to provide information useful to navigate the host-vehicle 12. That is, the camera 28, the radar-unit 30, and/or the lidar-unit 32 may be used by both the navigation-device 20 and the vehicle-detector 34.

It follows that the vehicle-detector 34 is also suitable for use on the host-vehicle 12, and is generally used by the controller 40 of the system 10 to determine a relative-location 36 of an other-vehicle 38 proximate to the host-vehicle 12. By way of example and not limitation, the relative-location 36 of the other-vehicle 38 may be expressed in terms of a bearing-angle (i.e. direction) relative to the forward facing direction of the host-vehicle 12, and a distance from the host-vehicle 12 to the other-vehicle 38. Alternatively, the relative-location 36 may be calculated from a difference in global coordinates indicated by the navigation-device 20 and an indication of the global coordinates of the other-vehicle 38 transmitted by the other-vehicle 38 using known vehicle-to-vehicle (V2V) communications.

As suggested in FIG. 1, the controller 40 is generally in communication with the navigation-device 20 and the vehicle-detector 34 which may be by way of wires, wireless communication, or optical-fiber, as will be recognized by those in the art. The controller 40 may include a processor (not specifically shown) such as a microprocessor or other control circuitry such as analog and/or digital control circuitry including an application specific integrated circuit (ASIC) for processing data as should be evident to those in the art. The controller 40 may include memory (not specifically shown), including non-volatile memory, such as electrically erasable programmable read-only memory (EEPROM) for storing one or more routines, thresholds, and captured data. The one or more routines may be executed by the processor to perform steps for determining, for example, the relative-location 36 based on signals received by the controller 40 for operating the host-vehicle 12 as described herein.

In one embodiment of the system 10, the controller 40 is configured to determine an alternate-route 44 when the relative-location 36 is such that a preferred-lane 46 of the preferred-route 22 is obstructed by the other-vehicle 38 for example. When this happens, the host-vehicle 12 is unable to follow the preferred-route 22. That is, if the presence of the other-vehicle 38 and/or numerous other-vehicles present in the preferred-lane 46 prevents the host-vehicle 12 from being able to comply with a lane-change-request 50 to complete a lane-change 52 into the preferred-lane 46, the system 10, or more specifically the controller 40, determines that the preferred-route 22 cannot be followed, so the alternate-route 44 is determined or selected to follow to the destination 16. By way of example and not limitation, the alternate-route 44 may specify a next-turn for the host-vehicle to take if an upcoming-turn that is indicated as the preferred-route is unavoidably missed.

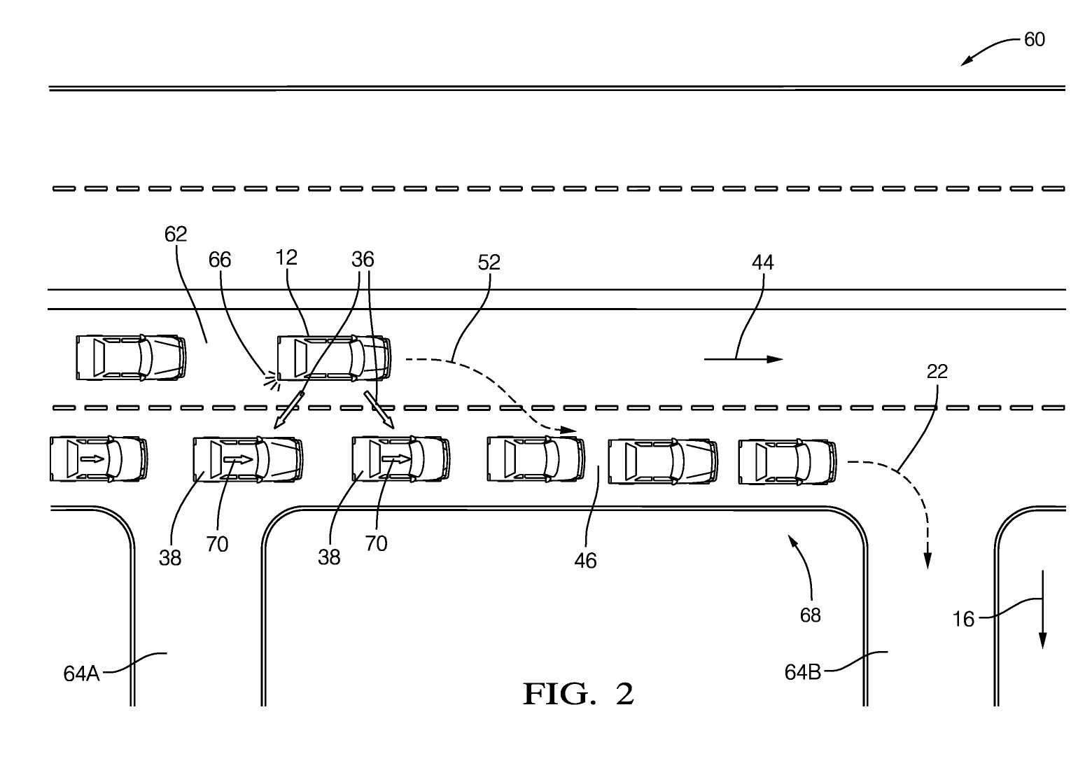

FIG. 2 illustrates a non-limiting example of a traffic-scenario 60 where the host-vehicle 12 needs to make the lane-change 52 into the preferred-lane 46 in order to follow the preferred-route 22. As noted above, in order to provide a pleasant travel experience to a passenger or occupant of the host-vehicle 12, it may be preferable for the host-vehicle 12 to travel in the left-lane 62 so the speed of the host-vehicle 12 is relatively constant when compared to the possible start/stop traffic caused by the numerous vehicles present in the preferred-lane 46, which may be making turns onto side-roads 64A, 64B. However, in order to prepare for the upcoming turn indicated by the preferred-route 22, the host-vehicle 12 needs to move into the preferred-lane 46 prior to the upcoming turn. That is, the optimum way to travel the preferred-route 22 is to stay in the left-lane 62 as long as possible, and make the lane-change 52 into the preferred-lane 46 as close as possible to the upcoming turn indicated by the arrow that represents the preferred-route 22.

In view of this preferred strategy when following the preferred-route 22, an alternative embodiment of the system 10 is envisioned that optimizes the timing for making the lane-change 52. In this alternative embodiment the controller 40 is configured to determine an initiate-time 48 (FIG. 1) to perform the lane-change 52 necessary to maneuver the host-vehicle 12 into the preferred-lane 46 of the preferred-route 22 so the host-vehicle 12 can follow the preferred-route 22. By way of example and not limitation, the initiate-time 48 may be determined based on the relative-location 36. That is, if the relative-location 36 is such that the lane-change 52 is not obstructed or blocked by the other-vehicle 38 or any of the multiple vehicles shown in FIG. 2 as present in the preferred-lane 46, the initiate-time 48 can be later, e.g. delayed until a time when the host-vehicle 12 is relatively close to the upcoming turn illustrated by the arrow for the preferred-route 22. However, if the relative-location 36 is such that the host-vehicle 12 is unable to make the lane-change 52 at any desired moment, the initiate-time 48 would be advantageously selected earlier so there was sufficient time for the host-vehicle 12 to take some action in order to find space to make the lane-change 52. By way of example and not limitation, if traffic in the preferred-lane 46 is relatively heavy and closely spaced, the host-vehicle 12 may mark the initiate-time 48 by activating a turn-signal 66 to indicate to the other-vehicles in the preferred-lane 46 that the lane-change 52 is desired.

Another embodiment is contemplated that combines the above described embodiments so that the controller 40 determines the initiate-time 48 based on the relative-location 36, and then if it is not possible to make the lane-change 52 before reaching the upcoming turn, the controller 40 abandons the preferred-route 22 and instead follows the alternate-route 44.

Alternatively, or in addition to relying on the relative-location 36 to determine the initiate-time 48, the controller 40 may be further configured to determine a traffic-density 68 based on how many other-vehicles are present in the preferred-lane 46, and further determine the initiate-time 48 based on the traffic-density 68. The traffic-density 68 may be determined using the vehicle-detector 34 and be based on the number of vehicles in the preferred-lane 46 within (e.g. forward and or behind) some predetermined distance of the host-vehicle, within fifty meters (50 m) for example. Alternatively, the average spacing between five other vehicles nearest the host-vehicle 12 and in the preferred-lane 46 may be used as a measure of the traffic-density 68. If the traffic-density 68 is relatively high, then an earlier value of the initiate-time 48 may be determined. For example, if the traffic-density 68 is relatively high, e.g. there are no spaces between the other vehicles in the preferred-lane 46 large enough for the host-vehicle 12 to occupy following the lane-change 52, the initiate-time 48 may be set to ninety seconds (90 s) prior to arriving at the upcoming turn indicated by the preferred-route 22. However, if the traffic-density 68 is relatively low so the host-vehicle 12 can readily make the lane-change 52, the initiate-time 48 may be set to fifteen seconds (15 s) prior to arriving at the upcoming turn.

Alternatively, or in addition to the embodiments describe above, the controller 40 may be further configured to determine a speed 70 (e.g. a mean or median) of other-vehicles present in the preferred-lane 46, and further determine the initiate-time 48 based on the speed 70. If the other-vehicles are moving at a relatively low speed, thirty-five kilometers per hour (35 kph) for example, the initiate-time 48 may be delayed as compared to when the other-vehicles are moving at a relatively high speed, one-hundred kilometers per hour (100 kph) for example.

Alternatively, or in addition to the embodiments describe above, the controller 40 may be further configured to determine a lane-count 72 and/or lane-width 74 of lanes that must be crossed to reach the preferred-lane 46, and further determine the initiate-time 48 based on the lane-count 72 and/or lane-width 74. For the example shown in FIG. 2, the lane-count 72 is one so the initiate-time 48 may be relatively short, fifteen seconds (15 s) for example. However, if the roadway has more than the two lanes for a direction of travel shown in FIG. 2, additional time may be required to transition across multiple-lanes and/or if the lane-width 74 is unusually large.

Alternatively, or in addition to the embodiments describe above, the navigation-device 20 may be used to detect a traffic-signal 76, and the controller 40 may be further configured to determine a signal-distance 78 from the host-vehicle 12 to the traffic-signal 76, and further determine the initiate-time 48 based on the signal-distance. That is, the system 10 is configured to decide when to perform lane-change 52 based on the signal-distance 78 to traffic-signal 76 while considering of the traffic-density 68 of the surrounding traffic. By way of further example, if the traffic-signal 76 is relatively close, e.g. within 10 seconds, the system 10 will not try to do a lane change before the traffic-signal or an upcoming intersection that may or may not have a traffic-signal, but will perform the traffic after the traffic-light or intersection. However, if there is a traffic-signal that is not too close, e.g. not less than within 20 seconds, and the traffic-density is relative high (i.e. the traffic is heavy), the system 10 will not try to perform a lane-change before this intersection. Otherwise, if the traffic-density is not too high when the traffic-signal that is not too close, e.g. not less than within 20 seconds, then the system 10 may perform the lane-change.

Accordingly, a lane management system (the system 10), a controller 40 for the system 10, and a method of operating the system 10 is provided. The system 10 is generally configured to, as much as possible, keep the host-vehicle in a travel-lane where traffic moves at a steady speed, and delay, as much as possible, making a lane-change into a lane where wide speed variation may be present, where the lane-change is necessitated by the desire to follow a preferred-route to a destination.

While this invention has been described in terms of the preferred embodiments thereof, it is not intended to be so limited, but rather only to the extent set forth in the claims that follow.

We claim:

1. A lane management system for operating an automated vehicle, said system comprising:
a navigation-device suitable for use on a host-vehicle, said navigation-device used to determine a preferred-route to a destination of the host-vehicle;
a vehicle-detector suitable for use on the host-vehicle, said vehicle-detector used to determine a relative-location of an other-vehicle proximate to the host-vehicle; and
a controller in communication with the navigation-device and the vehicle-detector, said controller configured to determine an alternate-route when the relative-location is such that a preferred-lane of the preferred-route is obstructed whereby the host-vehicle is unable to follow the preferred-route.

2. The system in accordance with claim 1, wherein the controller is further configured to determine an initiate-time to perform a lane-change necessary to maneuver the host-vehicle into the preferred-lane so the host-vehicle can follow the preferred-route, wherein the initiate-time is determined based on the relative-location.

3. The system in accordance with claim 2, wherein the controller is further configured to determine a traffic-density based on how many other-vehicles are present in the preferred-lane, and further determine the initiate-time based on the traffic-density.

4. The system in accordance with claim 2, wherein the controller is further configured to determine a speed of other-vehicles present in the preferred-lane, and further determine the initiate-time based on the speed.

5. The system in accordance with claim 2, wherein the controller is further configured to determine a lane-count of lanes that must be crossed to reach the preferred-lane, and further determine the initiate-time based on the lane-count.

6. A lane management system for operating an automated vehicle, said system comprising:
a navigation-device suitable for use on a host-vehicle, said navigation-device used to determine a preferred-route to a destination of the host-vehicle;
a vehicle-detector suitable for use on the host-vehicle, said vehicle-detector used to determine a relative-location of an other-vehicle proximate to the host-vehicle; and
a controller in communication with the navigation-device and the vehicle-detector, said controller configured to determine an initiate-time to perform a lane-change necessary to maneuver the host-vehicle into a preferred-lane of the preferred-route so the host-vehicle can follow the preferred-route, wherein the initiate-time is determined based on the relative-location.

7. The system in accordance with claim 6, wherein the controller is further configured to determine a traffic-density based on how many other-vehicles are present in the preferred-lane, and further determine the initiate-time based on the traffic-density.

8. The system in accordance with claim 7, wherein navigation-device is used to detect a traffic-signal, and the controller is further configured to determine a signal-distance from the host-vehicle to the traffic-signal, and further determine the initiate-time based on the signal-distance.

9. The system in accordance with claim 6, wherein the controller is further configured to determine a speed of other-vehicles present in the preferred-lane, and further determine the initiate-time based on the speed.

10. The system in accordance with claim 6, wherein the controller is further configured to determine an alternate-route when the relative-location obstructs the preferred-lane such that the host-vehicle is unable to follow the preferred-route.

11. The system in accordance with claim 6, wherein the controller is further configured to determine a lane-count of lanes that must be crossed to reach the preferred-lane, and further determine the initiate-time based on the lane-count.
